(19) United States
(12) Patent Application Publication
(10) Pub. No.: US 2025/0067576 A1
(43) Pub. Date: Feb. 27, 2025

(54) DISTANCE DETECTOR, PROCESSING HEAD AND PROCESSING DEVICE

(71) Applicant: Makeblock Co., Ltd., Shenzhen (CN)

(72) Inventor: Liang WANG, Shenzhen (CN)

(73) Assignee: Makeblock Co., Ltd., Shenzhen (CN)

(21) Appl. No.: 18/943,034

(22) Filed: Nov. 11, 2024

Related U.S. Application Data
(63) Continuation of application No. PCT/CN2024/090664, filed on Apr. 29, 2024.

(30) Foreign Application Priority Data
May 6, 2023 (CN) 202310509604.8
May 6, 2023 (CN) 202321078580.7

(51) Int. Cl. G01D 5/14

(52) U.S. Cl. CPC G01D 5/142

(57) ABSTRACT

A distance detector includes a housing a detection member and a trigger connected to the detection member. A part of the detection member is slidably inserted into the housing along a length direction of the detection member. The trigger is configured to move with a sliding of the detection member to trigger a sensing member provided at a first installation position.

### CROSS-REFERENCE TO RELATED APPLICATIONS

This application is a continuation application of International Application No. PCT/CN2024/090664, filed on Apr. 29, 2024, which claims priority to Chinese Patent Application Nos. 202310509604.8 and 202321078580.7, both filed on May 6, 2023. The disclosures of the above-mentioned applications are incorporated herein by reference in their entireties.

### TECHNICAL FIELD

The present application relates to the technical field of sensor, and in particular to a distance detector, a processing head and a processing device.

### BACKGROUND

In laser processing devices such as laser printers, laser engraving machines, or 3D printers, it is usually necessary to provide a distance detector to detect the distance between a processing head such as a laser head or a print nozzle and a processing surface. For example, it is necessary to provide a distance detector to detect the distance between the laser head and the processing surface to focus the laser on the processing surface, or to detect the distance between the print nozzle and the printing position to adjust the height of the print nozzle.

### SUMMARY

According to one or more embodiments of the present application, a distance detector, a processing head and a processing device are provided.

The present application provides a distance detector, including: a housing, a detection member, and a trigger connected to the detection member.

In an embodiment, a part of the detection member is slidably inserted into the housing along a length direction of the detection member; and the trigger is configured to move with a sliding of the detection member to trigger a sensing member provided at a first installation position.

The present application further provides a processing head including a housing and a sensing member, the housing includes a first installation position inside, the sensing member is provided at the first installation position, the housing includes a second installation position outside opposite to the first installation position, and the second installation position is provided with a distance detector.

In an embodiment, the second installation position includes a slide slot, and a part of the trigger of the distance detector is configured to extend through the slide slot to trigger the sensing member.

The present application further provides a processing device, including the processing head and the distance detector described above, a sensing member is provided inside the processing head, the distance detector is provided outside the processing head and opposite to the sensing member, and the distance detector is used to trigger the sensing member.

### BRIEF DESCRIPTION OF THE DRAWINGS

In order to more clearly illustrate the technical solutions in the embodiments of the present application or in the related art, drawings used in the embodiments or in the related art will be briefly described below. Obviously, the drawings in the following description are only some embodiments of the present application. It will be apparent to those skilled in the art that other figures can be obtained according to the structures shown in the drawings without creative work.

FIG. 1 is a structural diagram of a distance detector and a sensing member in a detection state according to one or more embodiment of the present application.

FIG. 2 is a structural diagram of the distance detector and the sensing member in FIG. 1 in an idle state.

FIG. 3 is a cross-sectional view of the distance detector and the sensing member in FIG. 1.

FIG. 4 is an enlarged view of point A in FIG. 3.

FIG. 5 is a structural diagram of the distance detector and the sensing member in the detection state according to another one or more embodiment of the present application.

FIG. 6 is an exploded view of FIG. 5.

FIG. 7 is a structural diagram of the distance detector in the detection state according to one or more embodiments of the present application.

FIG. 8 is a structural diagram of the distance detector in FIG. 7 in an idle state.

FIG. 9 is a structural diagram of a processing device according to one or more embodiments of the present application.

FIG. 10 is an enlarged view of point B in FIG. 9.

FIG. 11 is a diagram showing the matching structure of the distance detector and a pushing member in FIG. 10.

FIG. 12 is a structural diagram of a processing head in FIG. 9 according to one or more embodiments of the present application.

FIG. 13 is a structural diagram of FIG. 9 without the processing head and the distance detector.

FIG. 14 is a structural diagram of the distance detector fixed to the processing head according to another embodiment of the present application.

FIG. 15 is an exploded view of FIG. 14.

FIG. 16 is a structural diagram of the distance detector according to another one or more embodiments of the present application.

The realization of the purpose, functional features and advantages of the present application will be further described with reference to the embodiments and the accompanying drawings.

### DETAILED DESCRIPTION OF THE EMBODIMENTS

In order to enable those skilled in the art to better understand the present application, the following will be combined with the drawings in the embodiments of the present application to clearly and completely describe the technical solutions in the embodiments of the present application. Obviously, the described embodiments are only embodiments of a part of the present application, not all embodiments. Based on the embodiments in the present application, all other embodiments obtained by ordinary skilled in the art without creative work should fall within the scope of protection of the present application.

It should be noted that all of the directional instructions in the embodiments of the present disclosure (such as, up, down, left, right, front, rear . . . ) are only used to explain the relative position relationship and movement of each component under a specific attitude (as shown in the drawings), if the specific attitude changes, the directional instructions will change correspondingly.

In the present application, unless otherwise clearly stated and limited, the terms “connection”, “fixing”, etc. should be understood in a broad sense. For example, “fixing” can be a fixed connection, a detachable connection, or an integral body; it can be a mechanical connection or an electrical connection; it can be a direct connection or an indirect connection through an intermediate medium; it can be an internal connection between two elements or an interactive relationship between two elements, unless otherwise clearly limited. For those of ordinary skill in the art, the specific meanings of the above terms in the present application can be understood according to specific circumstances.

Besides, the descriptions in the present disclosure that refer to “first,” “second,” etc. are only for descriptive purposes and are not to be interpreted as indicating or implying relative importance or to implicitly indicate the number of technical features indicated. Thus, a feature defined as “first” or “second” may explicitly or implicitly include at least one of the features. Furthermore, the technical solutions of the various embodiments can be combined with each other, but such combinations must be based on the ability of those skilled in the art to implement them. If the combination of technical solutions results in contradictions or is unfeasible, it should be considered that such a combination does not exist and is not within the scope of protection claimed by the present application.

Some processing device adopts a probe-type distance detector, that is, a retractable detection member is provided to abut against the position to be detected, and a sensing member is provided in the distance detector, so that the sensing member can be triggered when the detection member abuts against the position to be detected and retracts to obtain the distance between the position to be detected and the processing head. The detection member is prone to wear due to long-term use and needs to be removed for replacement or adjustment and maintenance. At this time, the entire distance detector including the sensing member needs to be removed for repair or replacement, which is inconvenient for the maintenance of the distance detector.

The present application provides a distance detector 100.

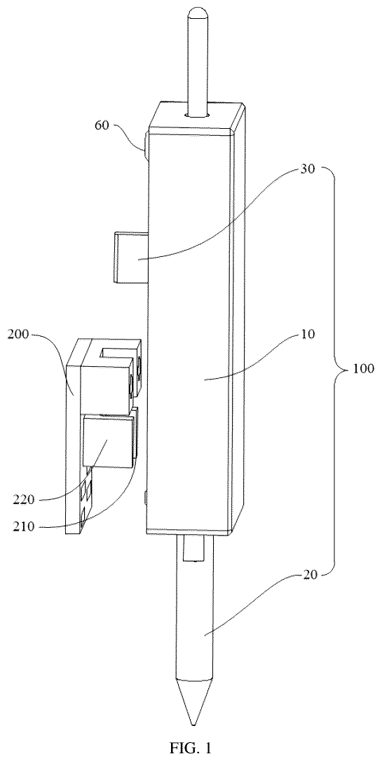

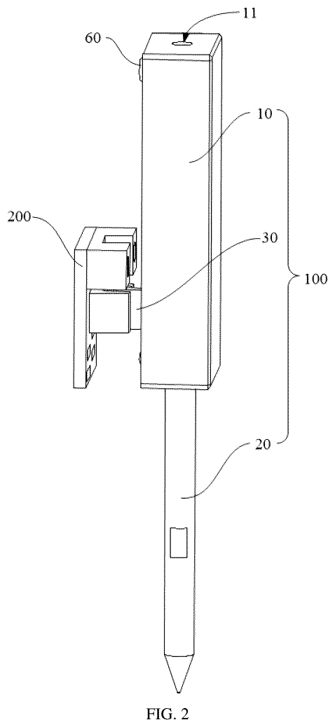

As shown in FIGS. 1 and 2, in some embodiments of the present application, the distance detector 100 includes: a housing 10, a detection member 20, and a trigger 30. A part of the detection member 20 is slidably inserted into the housing 10 along a length direction of the detection member 20. The trigger 30 is connected to the detection member 20 and can move with the extension and retraction of the detection member 20 to trigger the sensing member 200 located at the first installation position. In one or more embodiment, the detection member 20 moves in a vertical, reciprocating manner relative to the housing 10. When the detection member moves downward, it is considered to be in the extension position. Conversely, when the detection member 20 moves upward, it is considered to be in the retraction position.

The distance detector 100 provided in the present application is mainly used in laser processing device 1000 such as a laser engraving machine, a laser cutting machine, a laser marking machine, or processing device 1000 such as a printer. A first installation position for installing the distance detector 100 is provided on the processing device 1000. The first installation position can be provided on the processing head 320, and the distance detector 100 is provided on the processing head 320. In addition, the first installation position can also be provided on the frame or other positions of the processing device 1000. The distance detector 100 is generally used to detect the distance between the processing head 320 of the processing device 1000 and the processing position, or to detect the flatness of the processing surface, etc. For example, a laser head for emitting a laser processing beam is usually provided in the laser processing device 1000, and the laser focal length can be adjusted in real time by using the distance detector 100 to detect the distance between the laser head and the processing surface. 3D printers and the like have print heads, and the distance detector 100 is used to detect the distance between the print head and the processing position, such as the current quantity of printing layers and the distance between the print heads to adjust the height between the print heads. The distance detector 100 can also be used to detect the moving distance of the processing head 320 or other moving parts, etc., which is not limited here.

The distance detector 100 includes a housing 10 as an installation base, a detection member 20 slidably provided in the housing 10 for sensing physical signals, and a trigger 30 connected to the detection member 20. The detection member 20 can drive the trigger 30 to slide along the length direction of the detection member 20, and the trigger 30 can be directly connected to the detection member 20 or integrally formed, or it can be connected to the detection member 20 through a stopper 80 in the following embodiment, which is not limited here. When the distance detector 100 is applied to the processing device 1000, the sensing member 200 can be provided at a preset installation position on the processing device 1000, and the distance detector 100 can slide along the length direction of the detection member 20. For example, the sensing member 200 is provided on a processing head 320 such as a laser head or a printing nozzle. At this time, the distance detector 100 is also fixed on the processing head 320, cooperates with the sensing member 200, and can move and rise and fall with the processing head 320. In addition, a lifting mechanism or a translation mechanism can also be separately provided according to actual measurement needs for installing the distance detector 100, and the detection member 20 faces the processing surface to wait for the measurement position. When the detection member 20 contacts the position to be detected, the distance detector 100 continues to move to make the detection member 20 retract and drive the trigger 30 to slide, so that the trigger 30 triggers the sensing member 200 at the installation position, and the sensing member 200 generates an electrical signal, thereby completing the distance measurement process. At this time, the required measurement distance can be obtained according to the sliding distance of the distance detector 100, the telescopic length of the detection member 20, the initial distance between the trigger 30 and the sensing member 200, the distance between the end of the detection member 20 and the processing head 320, and the telescopic length of the detection member 20 during the signal delay process when there may be a signal delay.

The sensing member 200 and the trigger 30 can be a Hall component and a magnet, or a photoelectric sensing member and a shading component, or a pressure sensing member and a pressing component 331, and other matching sensing structures or a combination of at least two sensing structures. Taking the Hall component and the magnet as an example, the Hall component can sense the change of the magnetic field to generate a sensing signal. When the magnet moves with the retraction of the detection member 20, the magnetic field around the Hall component will change, thereby sending out an electrical signal to indicate that the detector has touched the processing surface. Similarly, when the pressing component 331 moves to change the pressure on the pressure sensing member, the pressure sensing member generates an electrical signal. When the light emitted from the transmitting end of the photoelectric sensing member is blocked by the shading component and cannot be emitted to the receiving end 220, or the shading component is moved away so that the receiving end 220 receives the light signal again, the photoelectric sensing member generates a sensing signal; thereby, the distance to be measure can be obtained according to the sliding distance of the distance detector 100, the telescopic length of the detection member 20 when the retraction of the trigger 30 causes the sensing member 200 to be triggered, the initial distance between the trigger 30 and the sensing member 200, and the distance between the end of the detection member 20 and the processing head 320. In an embodiment, it is also necessary to consider the delay time when the sensing member 200 generates and outputs an electrical signal, and consider the telescopic length of the detection member 20 during the delay process. In an embodiment, the detection member 20 will rebound and retract when it collides with the processing surface waiting for the measurement position, but then it will extend a certain distance due to the elastic reset member 40. Therefore, in some calculation manners, the rebound and telescopic distance of this section of the detection member 20 will also be considered and subtracted to make the measured distance value more accurate.

Therefore, it can be understood that the present application provides the sensing member 200 and the mechanical structures such as the detection member 20 separately, so that the sensing member 200 that needs to be powered or convert electrical signals is not provided in the distance detector 100, and only the mechanical structures such as the trigger 30 for triggering the sensing member 200 are provided. When the distance detector 100 is applied to the processing device 1000, the sensing member 200 is provided at the first installation position corresponding to the distance detector 100, and the distance detector 100 can slide along the length direction of the detection member 20, so that the detection member 20 can contact the measuring surface, and the detection member 20 can be extended relative to the housing 10 when it is abutted by the measuring surface to drive the trigger 30 to slide. When the trigger 30 slides or slides into place, the sensing member 200 on the first installation position is triggered, so that the sensing member 200 generates an electrical signal to feedback the measured distance and other information. With such a configuration, the distance detector 100 does not need an external power line and a signal line, so that the distance detector 100 is easy to install, and the installation convenience of the distance detector 100 is improved. When the detection member 20 is worn or damaged by external force, only the purely mechanical structure of the distance detector 100 can be removed for maintenance without removing the sensing member 200 together, thereby improving the maintenance convenience of the distance detector 100.

The distance to be measured can be obtained according to the sliding distance of the distance detector 100, the telescopic length of the detection member 20, the initial distance between the trigger 30 and the sensing member 200, the distance between the end of the detection member 20 and the processing head 320, and the telescopic length of the detection member 20 during the signal delay process when there may be a signal delay.

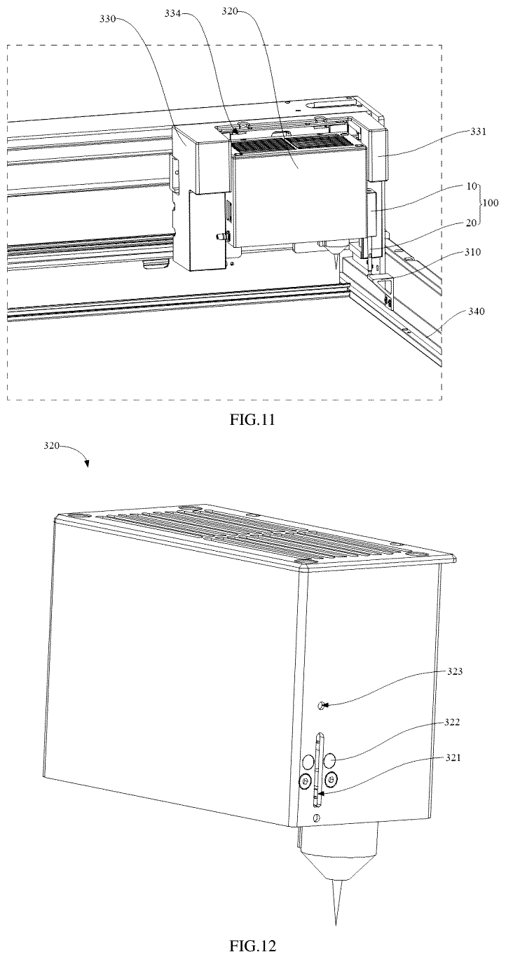

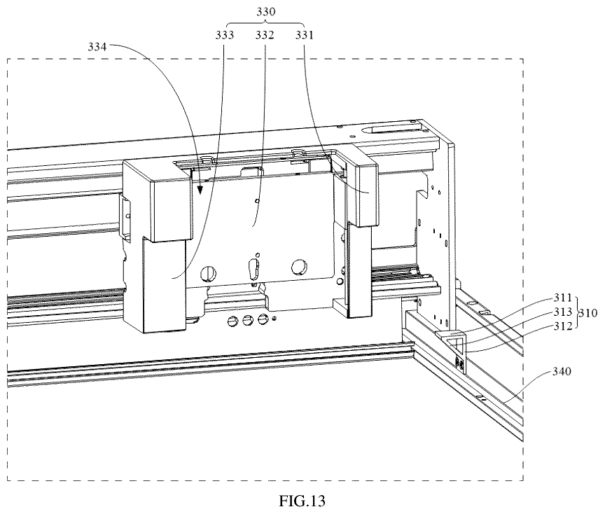

As shown in FIGS. 11 and 12, in some embodiments of the present application, the distance detector 100 is installed on the processing head 320. The processing head 320 includes the first installation position and the second installation position. The sensing member 200 is provided at the first installation position, and the distance detector 100 is provided at the second installation position. The first installation position is opposite to the second installation position.

It can be understood that the processing device 1000 of the present application can be a laser processing device such as a laser engraving machine, a laser cutting machine, a laser marking machine, or a processing device 1000 such as a printer, and correspondingly, the processing head 320 is a laser head or a printing nozzle. In an embodiment, the sensing member 200 and the distance detector 100 are both provided on the processing head 320, and are respectively located at the first installation position and the second installation position. Such an arrangement enables the distance detector 100 and the processing head 320 to move synchronously. At this time, the distance detector 100 can detect the distance between the position to be processed and the processing head 320 in real time, and the relative position of the distance detector 100 and the processing head 320 remains unchanged, avoiding the problem of inaccurate measurement caused by the height deviation due to the asynchronous movement distance when the distance detector 100 and the processing head 320 move separately, which is conducive to improving the measurement accuracy; and reducing the quantity of lifting structures and translation structures in the processing device 1000. Only one set of lifting structures and one set of translation mechanisms are required to enable the processing head 320 and the distance detector 100 to move synchronously, simplifying the structure of the processing device 1000.

As shown in FIGS. 11 and 12, in some embodiments of the present application, the processing head 320 includes a housing, the first installation position is inside the housing, and the second installation position is outside the housing.

It can be understood that the technical solution of the present application separates the sensing member 200 from the distance detector 100, thereby eliminating the need to connect power lines and signal lines to the distance detector 100, making the distance detector 100 easy to install, and the sensing member 200 does not need to be repeatedly disassembled and assembled, and thus does not need to be repeatedly wired. In an embodiment, the sensing member 200 is provided at a first installation position provided on the inner side of the housing 10 of the processing head 320, which can protect the sensing member 200, and the distance detector 100 is provided at a second installation position provided on the outer side of the housing 10 of the processing head 320, which can facilitate the disassembly and assembly of the distance detector 100.

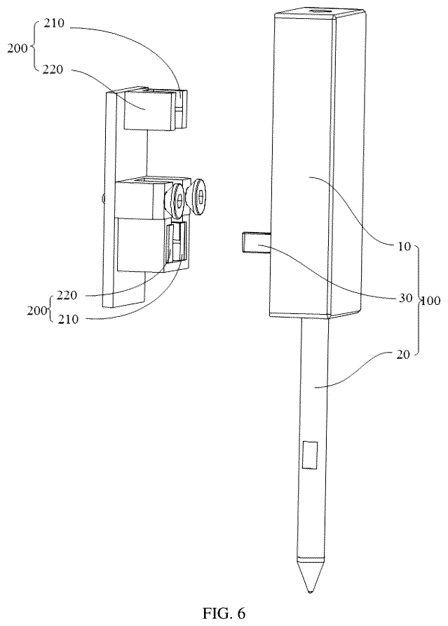

As shown in FIGS. 5 and 6, in some embodiments of the present application, a guide slot 14 extending along the length direction of the detection member 20 is provided on the side surface of the housing 10. The trigger 30 is inserted into the guide slot 14 and is at least partially located outside the housing 10. The trigger 30 can slide in the guide slot 14 as the detection member 20 is extended and retracted, so as to move with the sliding of the detection member 20 to trigger the sensing member 200.

The technical solution of the present application enables the sensing member 200 to be provided outside the housing 10 of the distance detector 100, and to be provided separately from the distance detector 100, so that the distance detector 100 is easy to maintain. At this time, the sensing member outside the housing 10 is triggered by the trigger 30 on the distance measuring detector 100. In an embodiment, the trigger 30 includes a connecting part provided inside the housing 10 and connected to the detection member 20, and a triggering part passing through the housing 10. The triggering part is connected to the connecting part, so that the triggering part of the distance detector 100 passes through the housing 10 from the guide slot 14 on the side of the housing 10, so as to reduce the distance between the trigger 30 and the sensing member 200, and improve the sensing accuracy and response speed between the trigger 30 and the sensing member 200.

As shown in FIGS. 5 and 6, in some embodiments of the present application, the sensing member 200 includes a transmitting end 210 and a receiving end 220 opposite to the transmitting end. The trigger 30 slides along the guide slot 14 to enter or leave the space between the transmitting end 210 and the receiving end 220. The trigger 30 is used to block the receiving end 220 from receiving the signal emitted by the transmitting end 210.

In an embodiment, the sensing member 200 includes a transmitting end 210 and a receiving end 220 opposite to the transmitting end 210. When the receiving end 220 normally receives the signal emitted by the transmitting end 210, the internal circuit of the sensing member 200 is turned on. When the receiving end 220 cannot receive the signal emitted by the transmitting end 210 or the received signal is weakened, the conduction state of the sensing member 200 will change, thereby generating a corresponding sensing signal. The sensing member 200 can be an electromagnetic sensor, and the signal transmitting end can emit electromagnetic waves; the sensing member 200 can also be an ultrasonic sensor, and the signal emitting section emits electromagnetic waves. In addition, the sensing member 200 can also be a photoelectric sensor in the following embodiments, which is not limited here. At this time, the part of the trigger 30 located outside the housing 10 can be driven to enter or leave between the transmitting end 210 and the receiving end 220 during the extension and retraction of the detection part, so that the conduction state of the sensing member 200 changes to trigger the sensing member 200 to feedback the measured distance and other information.

In some embodiments of the present application, the sensing member 200 is a photoelectric sensing member, and the part of the trigger 30 located outside the housing 10 is a light shielding member.

In an embodiment, the sensing member 200 is a photoelectric sensing member, which usually includes a transmitting end 210 and a receiving end 220 opposite to the transmitting end 210. The transmitting end 210 emits a light signal to the receiving end 220. When the light signal emitted from the transmitting end 210 to the receiving end 220 is blocked or the light path between the transmitting end 210 and the receiving end 220 is reopened so that the receiving end 220 receives the light signal again, the photoelectric sensing member will sense and generate an electrical signal. Therefore, in an embodiment, the part of the trigger 30 that passes through the housing 10 is a shading member, one end of the shading member is located in the housing 10 and is connected to the detection member 20, and another end of the shading member passes outward from the guide slot 14 on the side of the housing 10. The shading member can slide along the guide slot 14 when the detection member 20 is extended or retracted. The setting of the guide slot 14 can also guide and limit the extension and retraction of the detection member 20 and the shading member. However, when the distance detector 100 is applied to the processing device 1000, the shading piece slides with the extension and contraction of the detection member 20 to enter and exit the space between the transmitting end 210 and the receiving end 220 of the photoelectric sensing member, so that the photoelectric sensing member generates an electrical signal. For example, if the detection member 20 is at an idle position, the shading piece is located between the transmitting end 210 and the receiving end 220. At this time, the receiving end 220 cannot receive the optical signal, and the photoelectric sensing member is in an interrupted state. When the detection member 20 is compressed and retracted, the shading piece is driven to move so that the shading piece is withdrawn from the space between the transmitting end 210 and the receiving end 220 to conduct the light signal. And the receiving end 220 receives the light signal again to make the photoelectric sensing member generate an electrical signal. In addition, it is also possible that when the detection member 20 is at an idle position, the shading member is located outside the transmitting end 210 and the receiving end 220. At this time, the receiving end 220 normally receives the light signal of the transmitting end 210. When the detection member 20 is compressed and retracted, the shading piece is driven to move so that the shading piece enters the space between the transmitting end 210 and the receiving end 220 to hinder the transmission of the light signal. At this time, when the receiving end 220 detects that the received light intensity is weakened or disappears, the photoelectric sensing member generates an electrical signal.

As shown in FIG. 5 and FIG. 6, in some embodiments of the present application, at least two sensing members 200 are provided along the length direction of the detection part 10.

The sensing member 200 close to the detection end of the detection member 20 is used to detect that the detection member 20 is located at the detection position, and the sensing member 200 away from the detection end of the detection member 20 is used to detect that the detection member 20 is located at the idle position.

In an embodiment, the distance detector 100 includes a detection state and an idle state. When the distance detector 100 is in the detection state, the detection member 20 is naturally extended; when the distance detector 100 is not in use and is in the idle state, the detection member 20 can be retracted to avoid the detection member 20 from being extended too long and easily damaged by collision and impact, thereby reducing the risk of damage to the distance detector 100 in the idle state. In an embodiment, when the distance detector 100 is in the detection state, the position where the detection member 20 does not contact the position to be detected and maintains a naturally extended state under the support of the elastic reset member 40 is the detection position of the detection member 20. When the detection member 20 is at the detection position, the detection member 20 contacts the position to be detected and is subjected to force, it can be retracted into the housing 10 to achieve the measurement process; and when the distance detector 100 is not in use and is in the idle state, any position in the retraction direction of the detection member 20 in front of the detection position is the idle position of the retraction of the detection member 20, so that the detection member 20 retracts to the idle position when the distance detector 100 is in the idle state.

At this time, at least two sensing members 200 are provided on the device body 300, and at least two sensing members 200 are provided at intervals along the extension direction of the detection part 10, and two of the sensing members 200 are used to detect whether the detection member 20 is located at the idle position and the detection position. In an embodiment, when the detection member 20 retracts to the idle position, the sensing member 200 located above is triggered to send a sensing signal to indicate that the detection member 20 retracts to the idle position, or when the detection member 20 is misaligned with the idle position, the trigger 30 triggers the sensing member 200 to indicate that the detection member 20 moves away from the idle position or is ready to rebound to the detection position. When the detection member 20 drops to the detection position, the sensing member 200 located below can be triggered to indicate that the detection member 20 is located at the detection position and can perform distance detection. Or, when the detection member 20 retracts from the detection position, the sensing member 200 can be triggered to indicate that the detection member 20 has abutted against the position to be detected and retracted.

For example, taking the photoelectric sensing member as an example, when the detection member 20 is located at the detection position, the shading member is located between the photoelectric sensing members 200 below. At this time, the photoelectric sensing member is in an interrupted state. When the detection member 20 is compressed and retracted, the shading member is driven to rise and move out of the photoelectric sensing member, the photoelectric sensing member is reopened and generates a sensing signal; when the detection member 20 is located at the idle position, the shading member is located between the photoelectric sensing members 200 above. At this time, the photoelectric sensing member is in an interrupted state. When the detection member 20 is compressed and reset, the shading member is driven to descend and move out of the photoelectric sensing member, the photoelectric sensing member is reopened and generates a sensing signal.

In an embodiment, three or more sensing members 200 may also be provided to trigger sensing signals when the detection member 20 retracts to different positions in the housing 10, and to provide feedback on the retraction distance of the detection member 20 step by step.

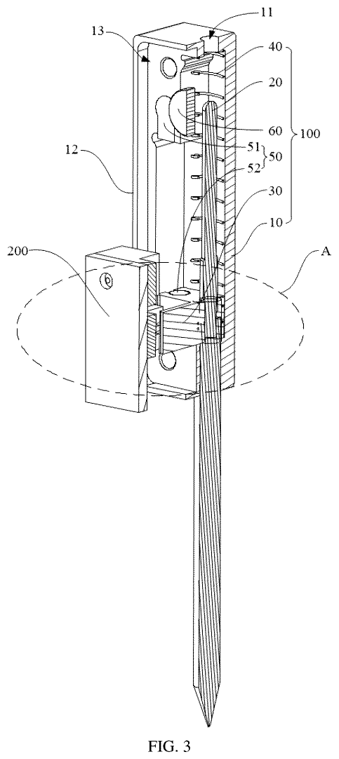

As shown in FIG. 3, in some embodiments of the present application, the distance detector 100 further includes an elastic reset member 40. The elastic reset member 40 is provided in the housing 10 and is drivingly connected to the detection member 20 to apply a force to the detection member 20 extending out of the housing 10.

In an embodiment, the state in which the detection member 20 is naturally ejected when the distance detector 100 is in the working state is taken as the detection position of the detection member 20. An elastic reset member 40 is provided in the distance detector 100, so that the elastic reset member 40 and the detection member 20 are drivingly connected, so that the detection member 20 has a tendency to be ejected out of the housing 10, so that the detection member 20 can be stably maintained at the detection position when not subjected to external force, to avoid the detection member 20 from rebounding due to the impact force when it contacts the waiting measurement position of the processing surface and falsely triggering the sensing member 200, resulting in inaccurate measurement. The elastic force applied by the elastic reset member 40 can play a buffering role to ensure that the detection member 20 is gradually pressed against the position to be detected and retracted, thereby improving the measurement accuracy. In addition, when the distance detector 100 is away from the processing surface after the measurement is completed, the elastic reset member 40 can drive the detection member 20 to reset to the detection position without the need for manual adjustment by the user, and without the need to provide up other complex electric drive structures to drive the detection member 20 to reset, thereby improving the convenience of use of the distance detector 100.

The elastic reset member 40 can be but not limited to an elastic ejector pin, a spring, an elastic airbag, etc. or a combination of at least two elastic structures, which is not limited here. In addition, in the present embodiment, the elastic reset member 40 can be provided at any position according to the requirements, for example, the housing 10 includes a top wall and a bottom wall opposite to the top wall, so that the detection member 20 is provided on the bottom wall. When the elastic reset member 40 is a spring, one end of the spring can be fixed on the bottom wall, and another end can be connected to the detection member 20. When the detection member 20 retracts, the spring is stretched. When the external force on the detection member 20 is removed, the spring retracts to extend the detection member 20 to reset; or the elastic ejector pin, spring, elastic airbag, etc., can be provided on the top wall. When the detection member 20 retracts, the elastic ejector pin, spring, elastic airbag, etc., are compressed. When the external force on the detection member 20 is removed, the elastic ejector pin, spring, elastic airbag rebounds and stretches to extend the detection member 20 to reset.

In some embodiments of the present application, a stopper 80 is provided in the housing 10, the trigger is connected to the side of the stopper 80, and the stopper 80 is sleeved outside the detection member 20 and fixedly connected to the detection member 20.

In an embodiment, a stopper 80 is provided in the housing 10 and connected to the detection member 20. With such a configuration, the stopper 80 can be used to limit the sliding distance of the detection member 20 relative to the housing 10, thereby limiting the length of the detection member 20 naturally extending outward under the action of the elastic reset member 40, improving the measurement accuracy and preventing the detection member 20 from completely sliding out of the housing 10, and ensuring the overall structural stability of the distance detector 100.

In addition, the stopper 80 is sleeved on the detection member 20. This configuration increases the connection area between the stopper 80 and the detection member 20, improves the connection strength between the stopper 80 and the detection member 20, and prevents the stopper 80 and the detection member 20 from loosening, which causes the detection position of the detection member 20 to change, thereby improving the measurement accuracy of the distance detector 100.

As shown in FIG. 3, in some embodiments of the present application, the housing 10 has a top wall and a bottom wall opposite to the top wall, and the detection member 20 is provided through the bottom wall.

The elastic reset member 40 is sleeved on the outer side of the detection member 20 and is provided between the top wall and the stop member 80.

In an embodiment, the elastic reset member 40 is provided on the side of the housing 10 close to the top wall, and is sandwiched between the top wall inside the housing 10 and the stopper 80. When the detection member 20 abuts against the position to be detected and retracts, the elastic reset member 40 is compressed and deformed. When the distance detector 100 is away from the position to be detected, the elastic reset member 40 rebounds to extend and reset the detection member 20. The elastic reset member 40 is provided on the side of the housing 10 close to the top wall to avoid the elastic reset member 40 from interfering with the expansion and contraction process of the detection member 20 other than elastic support. For example, when the elastic reset member 40 is provided on the side of the bottom wall, there may be a problem of friction between the side wall of the detection member 20 and the elastic reset member 40, which affects the measurement accuracy of the distance detector 100.

In addition, the elastic reset member 40 is sleeved on the detection member 20, and the detection member 20 can be used to limit the spring to avoid the elastic reset member 40 from being misplaced, so that the elastic reset member 40 can stably resist the stop member 80.

As shown in FIG. 2, in some embodiments of the present application, a top wall of the housing 10 is provided with an avoidance hole 11 opposite to the detection member 20, and one end of the detection member 20 inserted into the housing 10 can pass through the avoidance hole 11.

The distance detector 100 of the present application allows the detection member 20 to be extended and retracted relative to the housing 10 to drive the trigger 30 to move and thus trigger the sensing member 200. In an embodiment, the detection member 20 inserted into the housing 10 can be extended from the avoidance hole 11 at another end of the housing 10. Such an arrangement can reduce the length of the housing 10, and there is no need to provide a longer housing 10 for the detection member 20 to be extended and retracted, thereby reducing the volume of the distance detector 100 and reducing the installation position.

In an embodiment, an elastic reset member 40 is provided so that the detection member 20 can be pushed out and reset from the top wall of the housing 10 to the bottom wall side, and the elastic reset member 40 is sleeved on the outside of the detection member 20. In this way, the elastic reset member 40 can elastically support the detection member 20 without blocking the detection member 20 from extending from the avoidance hole 11.

In an embodiment, the distance detector 100 includes a detection state and an idle state. When the distance detector 100 is in the detection state, the detection member 20 is naturally extended; when the distance detector 100 is not in use and is in the idle state, the detection member 20 can be retracted to prevent the detection member 20 from being extended too long and easily damaged by collision and impact, thereby reducing the risk of damage to the distance detector 100 when it is in the idle state. At this time, the detection member 20 inserted into the housing 10 can be extended from the avoidance hole 11 at another end of the housing 10, so that the detection member 20 can be retracted a longer distance without being restricted by the length of the housing 10, and the length of the detection member 20 extended from the bottom wall can be shortened as much as possible, so as to fully reduce the risk of damage to the detection member 20 when the distance detector 100 is in the idle state.

As shown in FIGS. 1 to 4, in some embodiments of the present application, the detection member 20 includes a detection position and an idle position spaced apart along its length direction.

The distance detector 100 further includes a locking structure 50, which is provided in the housing 10 and is used to fix the detection member 20 at an idle position.

When the detection member 20 is at the idle position, the force applied by the locking structure 50 to the detection member 20 is greater than the force applied by the elastic reset member 40 to the detection member 20. When the detection member 20 is at the detection position, the force applied by the locking structure 50 to the detection member 20 is less than the force applied by the elastic reset member 40 to the detection member 20.

In an embodiment, the distance detector 100 includes a detection state and an idle state. When the distance detector 100 is in the detection state, the detection member 20 is naturally extended. When the distance detector 100 is not in use and is in the idle state, the detection member 20 can be retracted to avoid the detection member 20 being extended too long and easily damaged by collision and impact, thereby reducing the risk of damage to the distance detector 100 in the idle state.

In an embodiment, when the distance detector 100 is in the detection state, and the position in which the detection member 20 does not contact the position to be detected and maintains a naturally extended state under the support of the elastic reset member 40 is the detection position of the detection member 20. When the detection member 20 is at the detection position, and the detection member 20 contacts the position to be detected and is subjected to force, it can retract into the housing 10 to realize the measurement process. And when the distance detector 100 is not needed and is in the idle state, any position in front of the detection position in the retraction direction of the detector is the idle position in which the detection member 20 retracts. When the distance detector 100 is in the idle state, the detection member 20 can be locked by the locking structure 50 when the detection member 20 retracts to the idle position. At this time, the detector remains in this position and will not extend or continue to retract without external force. When the distance detector 100 is in the idle state, it is ensured that the detection member 20 always remains in the retracted state to avoid the detection member 20 extending too long and being easily damaged by collision and impact. The locking manner of the locking structure 50 on the detection member 20 can be one of the locking manners such as magnetic locking, Snap-On locking, plug-in locking, bonding, etc., or a combination of at least two locking manners, which is not limited here.

It can be understood that when the detection member 20 is at the idle position, the force applied by the locking structure 50 to the detection member 20 is greater than the force applied by the elastic reset member 40 to the detection member 20, so that the detection member 20 can be stably maintained at the idle position. At this time, when it is necessary to make the distance detector 100 detect, an external force is applied to make the locking structure 50 release the lock on the detection member 20, so that the detection member 20 is in the elastic reset member 40. In addition, when the detection member 20 is located at the detection position, the locking structure 50 does not apply external force to the detection member 20, or the force applied by the locking structure 50 to the detection member 20 can be smaller than the force applied by the elastic reset member 40 to the detection member 20. For example, when the locking structure 50 is the attraction structure of the magnetic suction member in the following embodiment, when the detection member 20 is located at the detection position, it is necessary to make the magnetic suction force between the first magnetic suction member 51 and the second magnetic suction member 52 smaller than the elastic force of the elastic reset member 40 to ensure that the detection member 20 is maintained at the detection position under the resistance force of the elastic reset member 40.

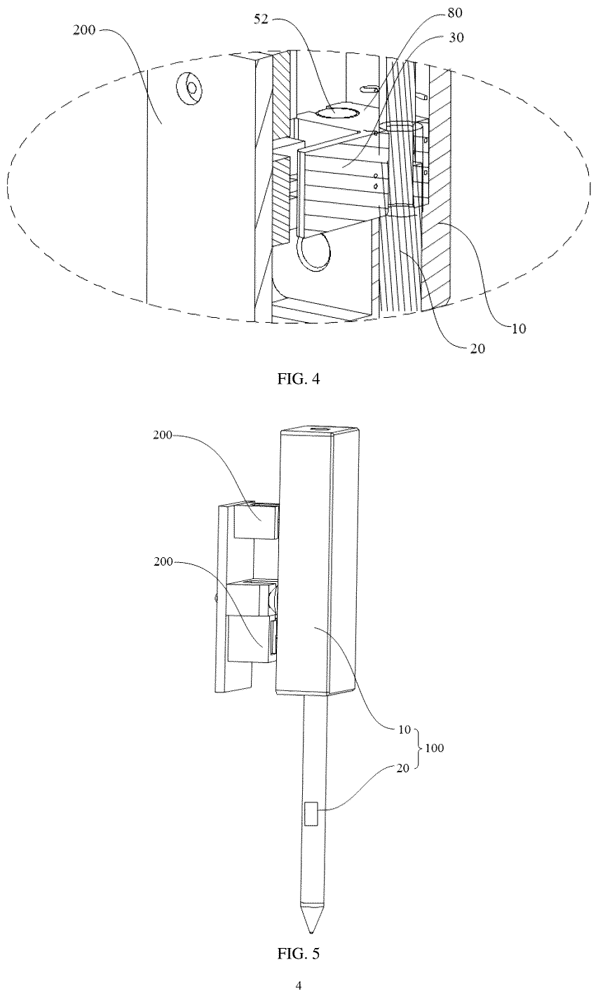

As shown in FIGS. 3 and 4, in some embodiments of the present application, the locking structure 50 includes a first magnetic member 51 and a second magnetic member 52, the first magnetic member 51 is provided on the housing 10, and at least one of the detection member 20 and the trigger 30 is provided with the second magnetic member 52.

The first magnetic member 51 and the second magnetic member 52 are attracted to each other when the detection member 20 is located at the idle position.

In an embodiment, the locking structure 50 includes the first magnetic member 51 and the second magnetic member 52 attracted to each other, so that the first magnetic member 51 is provided on the housing 10, and the trigger 30 is connected to the detection member 20. Therefore, the second magnetic member 52 can be provided on the detection member 20, or on the trigger 30, or the second magnetic member 52 can be provided on the detection member 20 and the trigger 30 at the same time. In an embodiment, a stopper 80 connected to the detection member 20 is provided in the housing 10, or the second magnetic member 52 can be provided on the stopper 80. In this way, when the distance detector 100 is in an idle state and the detection member 20 retracts to the idle position, the first magnetic member 51 and the second magnetic member 52 are attracted to each other, thereby locking the detection member 20 to prevent the detection member 20 from continuing to slide and retract. The first magnetic member 51 and the second magnetic member 52 can both be provided as magnets, and the magnetic poles of the first magnetic member 51 and the second magnetic member 52 are opposite to each other. Or, one of the first magnetic member 51 and the second magnetic member 52 can be a magnet, and another one can be iron, nickel, cobalt or other magnetic materials that can be attracted by magnets, which is not limited here.

In some embodiments of the present application, the detection member 20 includes a detection end and a force-bearing end, and the cross-sectional area of the force-bearing end gradually increases in a direction from the force-bearing end to the detection end.

In an embodiment, the detection member 20 is configured to include a detection end and a force-bearing end provided along the length direction. The force-bearing end is the end extending out of the housing 10 when the detection member 20 is at the detection position, and is used to abut against the position to be detected, and the detection end and the force-bearing end are spaced apart and are used to connect the trigger 30. Therefore, the cross-section of the part of the detection member 20 close to the force-bearing end gradually increases in the direction close to the detection end. With such a configuration, the abutting surface area of the force-bearing end used to abut against the position to be detected is smaller, so as to avoid the end face of the force-bearing end abutting against the structure on the side of the position to be detected that is higher than the position to be detected when measuring an uneven surface, resulting in inaccurate measurement, thereby ensuring that the detection member 20 accurately abuts against the position to be detected.

As shown in FIG. 3, in some embodiments of the present application, a peripheral edge 12 is protruded from the side of the housing 10, and the peripheral edge 12 encloses an avoiding space 13.

In an embodiment, a peripheral edge 12 is protruding from the side of the housing 10, and the peripheral edge 12 is provided around the circumference of the side of the housing 10 to form an avoidance space 13 on the side 333 of the housing 10, and the trigger 30 is provided in the avoidance space 13. In this way, when the distance detector 100 is used in the processing device 1000, the side cover where the peripheral edge 12 is located is provided at the installation position, and the peripheral edge 12 abuts against the surface of the installation position, so that the distance detector 100 can be supported at the installation position by the peripheral edge 12 to better support and fix the distance detector 100. In addition, the sensing member 200 and the trigger 30 are both located in the avoidance space 13, which can protect the sensing member 200 and the trigger 30. In an embodiment, the sensing member 200 on the processing device 1000 for cooperating with the distance detector 100 is provided as a photoelectric sensing member, and correspondingly, the trigger 30 of the distance detector 100 includes a light shielding sheet protruding from the housing 10. At this time, the peripheral edge 12 can also prevent external stray light from affecting the optical signal sensing of the photoelectric sensing member, thereby ensuring the measurement accuracy.

In an embodiment, the sensing member 200 can also be provided inside the installation position. For example, the sensing member 200 can be provided inside the processing head 320 of the processing device 1000, so that the trigger 30 is inserted into the processing head 320 and cooperates with the sensing member 200. This can also play a role in stably installing the distance detector 100, protecting the sensing member 200 and the trigger 30, and preventing the photoelectric sensing member from being affected by stray light.

As shown in FIG. 3, in some embodiments of the present application, a straight tube structure extending along the length direction of the detection member 20 is formed inside the housing 10.

The cross section of the part of the trigger 30 located in the housing 10 is adapted to the cross section of the straight tube structure, so that the trigger 30 can move along the straight tube structure as the detection member 20 slides.

The distance detector 100 of the present application is connected to the detection member 20 so as to slide in the housing 10 as the detection member 20 is extended and retracted, and the trigger 30 is sleeved on the detection member 20 to improve the connection strength between the detection member 20 and the trigger 30. In an embodiment, at least a section of the housing 10 for the trigger 30 to slide is formed into a straight tube structure, and the cross section of the trigger 30 located in the housing 10 is adapted to the cross section of the straight tube structure. At this time, the detection member 20 is inserted into the trigger 30. In this way, when the detection member 20 is extended and retracted with the trigger 30, the cooperation between the trigger 30 and the housing 10 plays a role of limiting and guiding, so that the detection member 20 can be stably extended and retracted along the length direction of the detection member 20, avoiding the deviation of the detection member 20 during the extension and retraction process and affecting the detection accuracy of the distance detector 100. The cross section of the straight tube structure and the trigger 30 located in the housing 10 can be circular, elliptical, rectangular, square, polygonal or other regular or irregular shapes, which are not limited here.

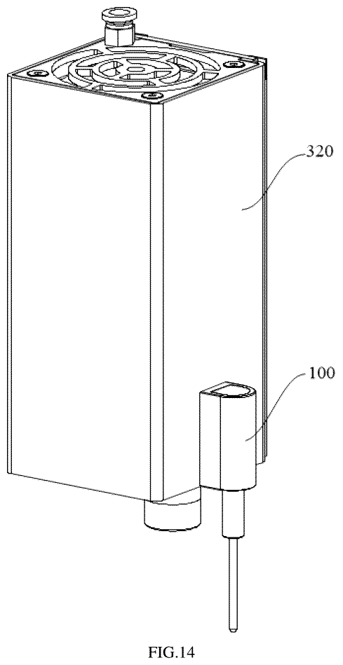

As shown in FIGS. 14 to 16, in some embodiments of the present application, the distance detector 100 is detachably installed on the processing head 320. The distance detector 100 further includes a magnetic structure 60. The magnetic structure 60 is provided on the housing 10 so that the distance detector 100 can be magnetically fixed at the second installation position.

In an embodiment, a magnetic structure 60 is provided on the distance detector 100. The magnetic structure 60 can be provided inside the housing 10 or on the installation surface of the side part 333 of the housing 10. It is only necessary to allow the distance detector 100 to magnetically fix the installation surface to the second installation position provided on the processing head 320. With such a configuration, when the distance detector 100 is impacted by an external object or force, the distance detector 100 can be displaced, or even fall off from the installation position, so that the distance detector 100 can be displaced to relieve force and buffer, thereby preventing the distance detector 100 from absorbing all the impact force and being easily damaged, thereby reducing the risk of damage.

It should be noted that the second installation position for installing the distance detector 100 on the processing head 320 can be such that a part of the area is a magnetic attraction area. When the distance detector 100 is impacted and displaced, it will be displaced in the magnetic attraction area and will not fall off directly from the second installation position. In an embodiment, only one attraction structure 322 cooperating with the magnetic structure 60 is provided at the second installation position. When the distance detector 100 is impacted and displaced, the magnetic structure 60 and the attraction structure 322 are misaligned, causing the distance detector 100 to fall off directly from the second installation position. Furthermore, when the distance detector 100 is displaced, the distance detector 100 or the processing device 1000 can send a warning signal and suspend the operation of the processing device 1000 until the abnormal situation is eliminated and the distance detector 100 is reset.

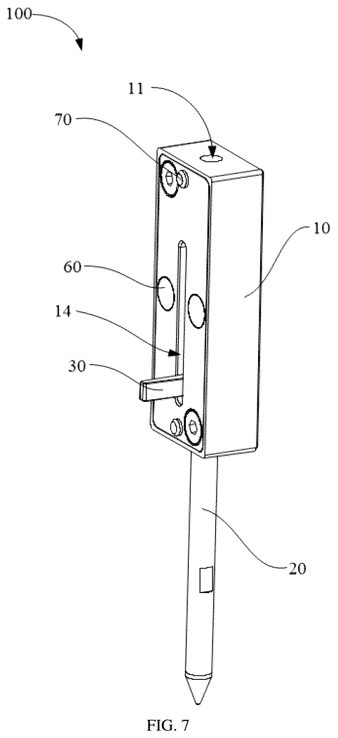

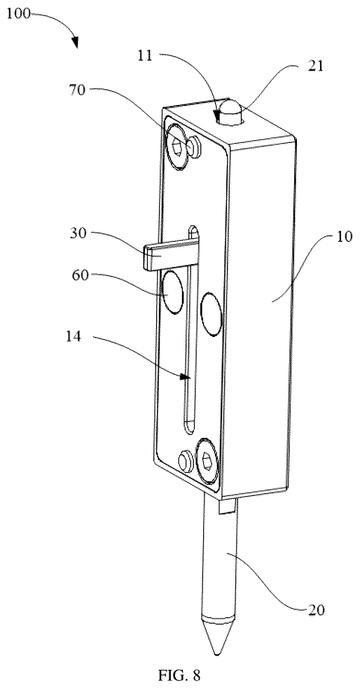

As shown in FIG. 7 and FIG. 8, in some embodiments of the present application, the magnetic structure 60 is provided on the installation surface.

In an embodiment, the magnetic structure 60 is provided on the installation surface of the housing 10. It can be understood that the closer the magnetic structure 60 is to the installation position, the stronger the magnetic attraction force is. Therefore, the magnetic structure 60 is provided on the installation surface to improve the connection strength of the distance detector 100 when it is fixed at the installation position. For example, the distance detector 100 needs to be moved with the laser head or the printing nozzle during the processing process. It is to avoid that the distance detector 100 has insufficient installation strength and shakes during the movement, resulting in position displacement, which affects the normal use and detection accuracy of the distance detector 100.

In some embodiments of the present application, a limiting groove is provided on the installation surface, and at least a part of the magnetic structure 60 is provided in the limiting groove.

In an embodiment, a limiting groove is provided on the installation surface, so that the magnetic structure 60 is embedded in the limiting groove to improve the connection strength between the magnetic structure 60 and the housing 10 and prevent the magnetic structure 60 from falling off the installation surface. The magnetic structure 60 can be completely embedded in the limiting groove so that the magnetic structure 60 does not protrude from the installation surface, or only a part of the magnetic structure 60 is embedded in the limiting groove so that a part of the magnetic structure 60 protrudes from the installation surface. At this time, it can be that as in the following embodiment, a peripheral edge 12 is provided on the installation surface to form an avoidance space 13, so that the part of the magnetic structure 60 protruding from the installation surface is enclosed in the avoidance space 13 to prevent the distance detector 100 from being unable to be firmly supported at the installation position due to the protrusion of the magnetic structure 60, or it can be that the protruding part of the magnetic structure 60 is used as a plug-in part to be plugged into the groove of the installation position, which is not limited here.

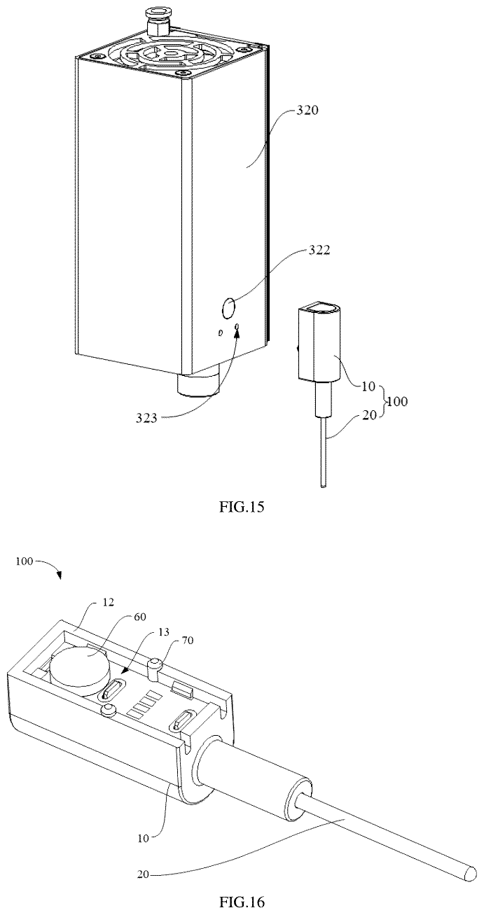

As shown in FIG. 16, in some embodiments of the present application, at least a part of the magnetic structure 60 is protruded from the installation surface to be plugged into and matched with a groove at the installation position.

In an embodiment, at least a part of the magnetic structure 60 is protruded from the installation surface to serve as a plug-in part, and a corresponding groove is provided at the installation position of the processing device 1000. When the distance detector 100 is installed at the installation position, the magnetic structure 60 is inserted into the groove. Such a configuration can improve the connection strength between the distance detector 100 and the installation position, thereby preventing the distance detector 100 from shaking during movement due to insufficient installation strength, causing position displacement, and affecting the normal use and detection accuracy of the distance detector 100.

The shape of the groove may be compatible with the magnetic structure 60, or may be slightly larger than the magnetic structure 60, which is not limited here.

In an embodiment, the sensing member 200 on the processing device 1000 for cooperating with the distance detector 100 is provided as a photoelectric sensing member, and correspondingly, the trigger 30 of the distance detector 100 has a light shielding piece protruding from the housing 10. At the same time, a peripheral edge 12 is provided on the installation surface of the housing 10 to enclose and form an avoidance space 13. In an embodiment, at least part of the magnetic structure 60 can be provided to protrude from the avoidance space 13 so as to be plugged into and cooperate with the groove at the installation position.

As shown in FIG. 16, in some embodiments of the present application, the outer surface of a part of the magnetic structure 60 protruding from the housing 10 is a curved surface.

The technical solution of the present application enables the distance detector 100 to be fixed to the installation position by magnetic attraction through the magnetic structure 60, so that when the distance detector 100 is hit or collided with external force, it can be displaced to relieve force and buffer, thereby reducing the risk of damage to the distance detector 100. In addition, in order to improve the installation stability of the distance detector 100 when it is in normal working state, the magnetic structure 60 is plugged into the groove at the installation position. In an embodiment, the part of the magnetic structure 60 protruding from the housing 10 is an arc surface structure, and the groove wall of the groove at the installation position is configured to imitate the arc surface of the magnetic structure 60. With such a configuration, when the distance detector 100 is hit or collided with external force and is displaced, the magnetic structure 60 can be disengaged from the groove under the guidance of the arc surface, thereby avoiding the distance detector 100 being difficult to disengage and unable to displace and relieve force due to the plug-in matching relationship when it is hit.

As shown in FIGS. 3, 7 and 12, in some embodiments of the present application, a side surface of the housing 10 is provided with one of a positioning part 70 and a positioning hole 323 to be plugged and matched with the positioning hole 323 or the positioning part 70 at the second installation position.

In an embodiment, the installation surface is convexly provided with a positioning part 70 or concavely provided with a positioning hole 323, and correspondingly, a positioning hole 323 is provided at the second installation position or a positioning part 70 is convexly provided. In this way, when the distance detector 100 is installed at the installation position, the positioning part 70 is inserted into the positioning hole 323 to locate the installation position of the distance detector 100, which facilitates the positioning and installation of the distance detector 100 and improves the installation convenience of the distance detector 100.

As shown in FIG. 16, in an embodiment, a peripheral edge 12 is convexly provided on the installation surface. The positioning part 70 or the positioning hole 323 may be provided on the peripheral edge 12, which is not limited here.

In some embodiments of the present application, a side surface of the positioning part 70 forms a guiding slope.

The technical solution of the present application enables the distance detector 100 to be fixed to the installation position by magnetic attraction through the magnetic structure 60, so that when the distance detector 100 is hit or collided with external force, it can be displaced to relieve force and buffer, thereby reducing the risk of damage to the distance detector 100. In addition, in order to facilitate the positioning and installation of the distance detector 100 and improve the installation strength of the distance detector 100, a positioning part 70 is protruded on the installation surface and plugged into the positioning hole 323 of the installation position. In an embodiment, the positioning part 70 is roughly a conical or truncated cone structure, that is, the cross section of the positioning part 70 is gradually reduced in the direction away from the installation surface, so that the side of the positioning part 70 serves as a guiding inclined surface. As such configuration, when the distance detector 100 is hit or collided with external force and is displaced, the positioning part 70 can be disengaged from the positioning hole 323 under the guidance of the guiding inclined surface, thereby avoiding the distance detector 100 being difficult to disengage and unable to displace and relieve force due to the plug-in matching relationship between the positioning part 70 and the positioning hole 323 when being hit.

As shown in FIG. 7 and FIG. 16, in some embodiments of the present application, two positioning parts 70 are provided.

In an embodiment, two positioning parts 70 are provided on the housing 10. This arrangement further improves the positioning accuracy of the distance detector 100 when it is installed at the installation position, and also improves the installation strength of the distance detector 100.

In an embodiment, part of the magnetic structure 60 protrudes from the installation surface to serve as a plug-in part to be plugged into a groove at the installation position. The two positioning parts 70 and the plug-in part may not be located on the same horizontal line, so that the two positioning parts 70 and the plug-in part are distributed in a triangular shape. The triangular structure has high stability and can further improve the installation strength of the distance detector 100.

As shown in FIG. 12, the present application further provides a processing head 320 including a housing and a sensing member 200. The housing includes a first installation position inside, and the sensing member 200 is provided at the first installation position. The housing includes a second installation position opposite to the first installation position outside, and the second installation position is provided with a distance detector 100. The second installation position is provided with a slide slot 321, and a part of the trigger 30 of the distance detector 100 is inserted into the slide slot 321 to trigger the sensing member 200.

The processing head 320 provided in the present application can be a laser head for emitting a laser processing beam in the laser processing device 1000, or a printing nozzle or processing structure on other equipment provided by a 3D printer. The processing head 320 includes a housing as an installation base, and the housing can integrate various devices provided by the processing head 320. A first installation position is provided inside the housing, and a second installation position is provided on the outer wall of the housing and opposite to the first installation position. The sensing member 200 is provided at the first installation position provided on the inner side of the housing of the processing head 320, which can protect the sensing member 200, and the distance detector 100 is provided at the second installation position provided on the outer side of the housing of the processing head 320, which is convenient for the disassembly and assembly of the distance detector 100.

The specific structure of the distance detector 100 refers to any one of the aforementioned embodiments. The distance detector 100 includes a trigger 30 for triggering the sensing member 200, and a slide slot 321 is correspondingly provided on the side wall of the housing of the processing head 320, so that part of the trigger 30 of the distance detector 100 passes through the slide slot 321 and enters the processing head 320, so as to reduce the distance between the trigger 30 and the sensing member 200, and improve the sensing accuracy and response speed between the trigger 30 and the sensing member 200.

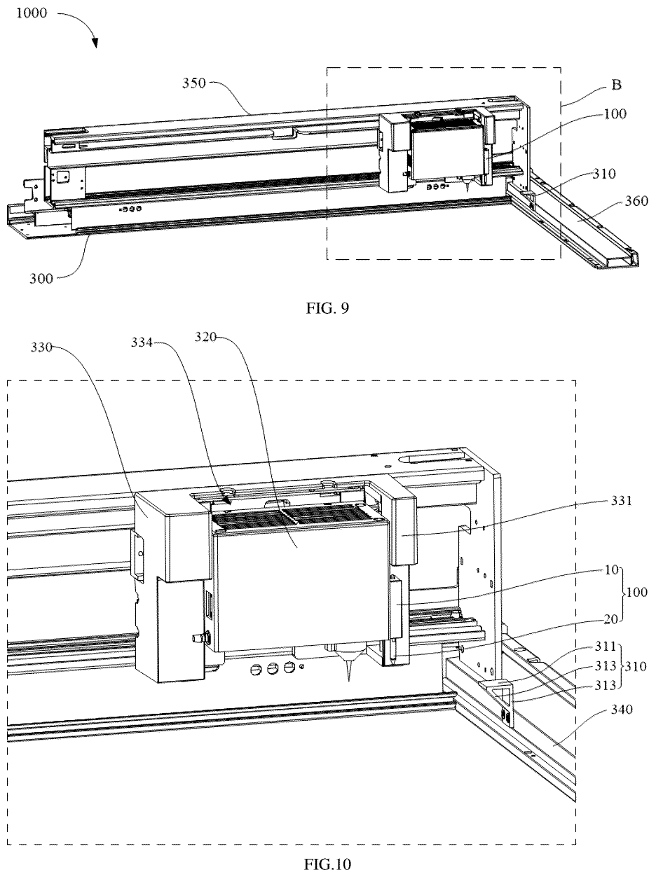

As shown in FIG. 9, the present application further provides a processing device 1000, which includes a processing head 320 and a distance detector 100 as described in any of the above items. The processing head 320 includes a first installation position and a second installation position. The first installation position is provided with a sensing member 200; the distance detector 100 is provided at the second installation position. The specific structure of the distance detector 100 refers to any one of the above embodiments and will not be repeated here. The processing device 1000 provided in the present application can be a laser processing device 1000 such as a laser engraving machine, a laser cutting machine, a laser marking machine, or a printer, etc. The distance detector 100 is generally used to detect the distance between the processing head 320 of the processing device 1000 and the processing position, or to detect the flatness of the processing surface, etc. For example, a laser head for emitting a laser processing beam is usually provided in the laser processing device, and the laser focal length can be adjusted in real time by using the distance detector 100 to detect the distance between the laser head and the processing surface. The 3D printer, etc., includes a print head, and the distance detector 100 is used to detect the distance between the print head and the processing position, such as the current quantity of printing layers and the distance between the print heads to adjust the height between the print heads. In addition, the distance detector 100 can also be used to detect the moving distance of the processing head 320 or other moving parts, etc., which is not limited here. In addition, the distance detector 100 can be directly fixed on the processing head 320 to move with the processing head 320, or a lifting mechanism or a translation mechanism can be separately provided according to actual measurement requirements for installing the distance detector 100, which is not limited here.

The distance detector 100 of the present application is provided as a purely mechanical structure. When the distance detector 100 is applied to the processing device 1000, the distance detector 100 can slide along the length direction of the detection member 20, so that the detection member 20 can contact the measuring surface, and when the detection member 20 is abutted by the measuring surface, it can be retracted relative to the housing 10 to drive the trigger 30 to slide. When the trigger 30 slides or slides into place, it triggers the sensing member 200 on the first installation position, so that the sensing member 200 generates an electrical signal to feedback the measured distance and other information. The distance detector 100 of the present application is not provided with the sensing member 200 requiring to be powered or convert electrical signals, the sensing member 200 is provided on the processing device 1000, so that the distance detector 100 is only provided with a trigger 30 and other mechanical structures for triggering the sensing member 200. With this arrangement, the distance detector 100 does not need an external power line and a signal line, etc., so that the distance detector 100 is easy to install, and the installation convenience of the distance detector 100 is improved. When the detection member 20 is worn or damaged by external force, only the purely mechanical structure of the distance detector 100 can be removed for maintenance without removing the sensing member 200 together, thereby improving the maintenance convenience of the distance detector 100.

The distance detector 100 is fixed on the processing head 320 so that the distance detector 100 and the processing head 320 move synchronously. The distance detector 100 can detect the distance between the processing position and the processing head 320 in real time, and the relative positions of the distance detector 100 and the processing head 320 remain unchanged, thereby avoiding the problem of inaccurate measurement caused by height deviation due to asynchronous movement distance that is easy to occur when the distance detector 100 and the processing head 320 move separately, which is beneficial to improving measurement accuracy. The quantity of lifting structures and translation structures in the processing device 1000 is reduced. Only one set of lifting structures and one set of translation mechanisms are required to make the processing head 320 and the distance detector 100 move synchronously, thereby simplifying the structure of the processing device 1000.

Since the processing device 1000 provided in the present application applies all the technical solutions of all the aforementioned embodiments, it at least has all the beneficial effects brought by all the aforementioned technical solutions, which will not be described one by one here.

As shown in FIGS. 11 and 12, in some embodiments of the present application, the processing device 1000 is provided with a processing head 320, the sensing member 200 is provided on the processing head 320, the processing head 320 can be raised and lowered, the distance detector 100 is provided on the side of the processing head 320, and the detection member 20 of the distance detector 100 extends along the height direction.

As shown in FIGS. 10 and 12, in some embodiments of the present application, the sensing member 200 is provided in a processing head 320 of the processing device 1000, and a slide slot 321 extending in a height direction is provided on a side wall of the processing head 320;

Part of the trigger 30 of the distance detector 100 is inserted into the slide slot 321 and enters the processing head 320 to trigger the sensing member 200 during the lifting process of the detection member 20.

In an embodiment, the sensing member 200 is provided on the processing head 320, so that the distance detector 100 can also be installed on the processing head 320 and move synchronously with the processing head 320, which is beneficial to improve the measurement accuracy and simplify the structure of the processing device 1000. In addition, the sensing member 200 is provided inside the processing head 320 to protect the sensing member 200 and avoid affecting the installation of the distance detector 100 when the sensing member 200 is provided on the outer side of the processing head 320. A slide slot 321 extending in the height direction is provided on the side of the processing head 320, so that part of the trigger 30 passes through the slide slot 321 and enters the processing head 320, so as to reduce the distance between the trigger 30 and the sensing member 200, and improve the sensing accuracy and response speed between the trigger 30 and the sensing member 200.

In an embodiment, the sensing member 200 is a photoelectric sensing member, and the trigger 30 is provided with a shading component to cooperate with the photoelectric sensing member, so that the shading component of the distance detector 100 passes through the slide slot 321 and enters the processing head 320, and the shading component can slide along the slide slot 321 to enter and exit between the transmitting end 210 and the receiving end 220 of the photoelectric sensing member; at this time, arranging the photoelectric sensing member inside the processing head 320 can also prevent external stray light from affecting the transmission of optical signals between the transmitting end 210 and the receiving end 220.

The distance detector 100 and the processing head 320 are detachably connected. The side wall of the processing head 320 is provided with an attraction structure 322. The distance detector 100 is provided with a magnetic structure 60. The magnetic structure 60 is connected to the attraction structure 322 to fix the distance detector 100 on the processing head 320.

In an embodiment, a magnetic structure 60 is provided on the distance detector 100. The magnetic structure 60 can be provided inside the housing 10 or on the installation surface of the side part 333 of the housing 10. It is only necessary to allow the distance detector 100 to magnetically fix the installation surface to the second installation position provided on the processing head 320. With such a configuration, when the distance detector 100 is impacted by an external object or force, the distance detector 100 can be displaced, or even fall off from the installation position, so that the distance detector 100 can be displaced to relieve force and buffer, thereby preventing the distance detector 100 from absorbing all the impact force and being easily damaged, thereby reducing the risk of damage.

It should be noted that an attraction structure 322 cooperating with the magnetic structure 60 is provided at the second installation position for installing the distance detector 100 on the processing head 320. When the distance detector 100 is displaced by impact, the magnetic structure 60 and the attraction structure 322 are misaligned so that the distance detector 100 directly falls off from the second installation position. In an embodiment, when the distance detector 100 is displaced, the distance detector 100 or the processing device 1000 can send a warning signal and suspend the operation of the processing device 1000 until the abnormal situation is eliminated and the distance detector 100 is reset.

As shown in FIGS. 10 and 11, in some embodiments of the present application, the device body 300 is provided with a state conversion member. The detection member 20 includes a detection position and an idle position provided along the height direction relative to the housing 10. When the detection part needs to switch the position relative to the housing 10, the state conversion member is provided relative to the detection member 20, and the state conversion member is used to adjust the position of the detection member 20 so that the detection member 20 moves between the idle position and the detection position.

In an embodiment, a state conversion member is provided on the device body 300 of the processing device 1000, and the state conversion member can drive the detection member 20 to move relative to the housing 10 to adjust the position of the detection member 20 relative to the housing 10. The state conversion member can be a pushing member 310. When the distance detector 100 is not in use, the distance detector 100 can be moved to the detection member 20 and the pushing member 310 to be provided opposite to each other. The distance detector 100 is driven to move toward the pushing member 310 so that the detection member 20 abuts against the pushing member 310, so that the detection member 20 can be retracted to the idle position under the action of the pushing member 310 so that the distance detector 100 is in an idle state. In addition, the state conversion component may further include a pressing member 331 provided on the device body 300, so that when the detection member 20 needs to be moved to the detection position, the pressing member 331 abuts against the detection member 20 to drive the detection member 20 to move to the detection position relative to the housing 10. Or, an elastic ratchet mechanism such as that used in a push-type ballpoint pen may be used between the detection member 20 and the housing 10. The state conversion component may only have a pushing member 310, and the detection member 20 can be repeatedly converted between the idle position and the detection position by repeatedly pressing the detection member 20.

In an embodiment, the state conversion member may further include an electromagnet assembly, and a magnet needs to be provided on the detection member 20 accordingly. When the position of the detection member 20 needs to be adjusted, the electromagnet assembly can be used to generate an adsorption force of the adsorbing magnet or a thrust force to repel the magnet when it is energized, so that the detection member 20 moves from the detection position to the idle position or from the idle position to the detection position. Two sets of electromagnet assemblies can be provided to respectively drive the detection member 20 from the detection position to the idle position and to drive the detection member 20 from the idle position to the detection position. Or, at least one set of electromagnet assemblies and a pushing member 310 as in the above embodiment can be provided to drive the detection member 20 from the detection position to the idle position, or at least one set of electromagnet assemblies and a pressing member 331 can be provided to drive the detection member 20 from the idle position to the detection position.

It should be noted that a locking structure 50 can be provided in the distance detector 100 to lock the detection member 20 when the detection member 20 moves to the idle position relative to the housing 10 to prevent the detection member 20 from moving to the detection position when the distance detector 100 is away from the state conversion member. The locking structure 50 can be a non-electromagnetic magnetic member, a bonding structure such as Velcro, a Snap-On structure, an interference fit structure, etc., which are not limited here.

Therefore, it can be understood that in the processing device 1000 of the present application, a state conversion member is provided on the device body 300 of the processing device 1000 to adjust the position of the detection member 20 in the distance detector 100 relative to the housing 10. The state conversion member can use an electromagnet assembly to drive the detection member 20 to move through magnetic force, or can use direct contact with the detection member 20 to drive the detection member 20 to move. When it is necessary to adjust the position of the detection member 20 to switch the use state of the distance detector 100, the detection member 20 is provided relative to the state conversion member. When the distance detector 100 is not needed to measure the distance, the state conversion member can drive the detection member 20 to retract to the idle position to prevent the detection member 20 from being extended too long and easily damaged and affecting the processing. When the detection member 20 is needed to measure the distance, the state conversion member can drive the detection member 20 to extend relative to the housing 10 to move to the detection position. That is, the present application provides the state conversion component on the device body 300 of the processing device 1000, so that there is no need to manually press the detection member 20 to retract the detection member 20, making the distance detector 100 more convenient to use in the processing device 1000. In addition, there is no need to provide a driving structure such as an electromagnet in the distance detector 100 to drive the detection member 20 to retract, thereby avoiding the structure of the distance detector 100 being too complicated.

As shown in FIGS. 7 and 8, in some embodiments of the present application, the detection member 20 includes a pressing part 21, and the pressing part 21 is exposed outside the housing 10 at least when the detection member 20 is at an idle position.

The state conversion member includes a pressing member 331, and the pressing part 21 is used to abut against the pressing part 21 to move the detection member 20 from the idle position to the detection position.

In an embodiment, in order to enable the distance detector 100 to switch from the idle state to the detection state, that is, to enable the detection member 20 to be unlocked from the idle position and dropped to the detection position so as to be retracted for detection at the detection position, a pressing member 331 is provided on the device body 300 as a state conversion member, and a pressing part 21 is provided on the detection member 20 of the distance detector 100. In this way, when it is necessary to switch the distance detector 100 from the idle state to the detection state, even if the detection member 20 is unlocked from the idle position and dropped to the detection position, the pressing part 21 of the distance detector 100 can be provided opposite the pressing member 331, and the distance detector 100 can be close to the pressing member 331, so that the pressing member 331 presses the pressing part 21 to drive the detection member 20 to unlock from the idle position and move to the detection position. In this way, the distance detector 100 is switched from the idle state to the detection state by a purely mechanical structure, and there is no need to provide a complex driving structure in the distance detector 100 or manually drive the detection member 20 to switch the state.

It should be noted that, in the present embodiment, the pressing part 21 can be protruded from the side wall of the detection member 20, so that the pressing part 21 passes through the side of the housing 10, or the pressing part 21 is always located above the top of the housing 10. In addition, the upper end of the detection member 20 can be directly used as the pressing part 21. The detection member 20 can be provided through the housing 10, that is, the upper end of the detection member 20 always protrudes from the top surface of the housing 10, or the upper end of the detection member 20 protrudes from the top of the housing 10 when the detection member 20 is retracted to the idle position or is a certain distance away from the idle position, which is not limited here.

As shown in FIGS. 9 to 11, in some embodiments of the present application, the device body 300 is further provided with a motion frame 330 including a back plate 332 and a bracket 333. The back plate 332 is slidably connected to the bracket 333, and the pressing member 331 is provided on the bracket 333.

In an embodiment, the device body 300 includes a motion frame 330 for fixing the distance detector 100, the distance detector 100 is provided on the back plate 332 of the motion frame 330, and the pressing member 331 is provided on the bracket 333 of the motion frame 330. Such a configuration allows the distance detector 100 to slide relative to the bracket 333, so that the distance detector 100 can approach or move away from the pressing member 331, so that the pressing member 331 can drive the detection member 20 to extend and retract relative to the housing 10 to move from the idle position to the detection position.

In an embodiment, the motion frame 330 can also be used to fix the processing head 320. The processing head 320 is slidably provided on the back plate 332 of the motion frame 330, which increases the installation and connection area of the processing head 320, is conducive to increasing the connection strength and position stability of the processing head 320 on the device body 300, reducing the risk of the processing head 320 falling, and improving the safety of use. The distance detector 100 can be provided on the processing head 320, so that the pressing member 331 can cooperate with the pressing part 21 of the detection member 20 during the lifting process of the processing head 320 relative to the motion frame 330.

In some embodiments of the present application, the pressing member 331 is protruded from the surface of the bracket 333, the distance detector 100 is provided below the pressing member 331, and the pressing part 21 of the detection member 20 is provided corresponding to the pressing member 331.

In this arrangement, when the distance detector 100 rises relative to the pressing member 331 until the pressing part 21 abuts against the pressing member 331, the pressing member 331 can limit the detection member 20 from continuing to rise, so that when the housing 10 of the distance detector 100 continues to rise, the detection member 20 can move relative to the housing 10 and move from the idle position to the detection position, and the structure is relatively simple.

As shown in FIGS. 1 and 10, in some embodiments of the present application, the detection member 20 is provided with a detection part, and the detection part is exposed outside the housing 10 at least when the detection member 20 is at the detection position.

The state conversion member includes a pushing member 310, and the pushing member 310 is used to abut against the detection part to move the detection member 20 from the detection position to the idle position.

In an embodiment, a pushing member 310 is provided on the device body 300 as a state conversion member, which is used to drive the detection member 20 to move relatively from the detection position to the idle position. The detection member 20 is configured to include a detection part for contacting with the position to be detected. It can be understood that the detection part is exposed outside the housing 10 at least when it is at the detection position. When the distance detector 100 is not in use, the distance detector 100 can be moved to the detection part and opposite the pushing member 310. When the distance detector 100 is driven to move toward the pushing member 310, the detection part and the pushing member 310 are contacted, so that the detection member 20 can be retracted to the idle position under the action of the pushing member 310, so that the distance detector 100 is in an idle state. In this way, a purely mechanical structure is used to convert the distance detector 100 from the detection state to the idle state, and there is no need to provide a complex driving structure in the distance detector 100 or manually drive the detection member 20 to switch the state.

It should be noted that, in the present embodiment, the pushing member 310 may be movably provided on the device body 300 to drive the pushing member 310 to move to a position opposite the detection member 20. The distance detector 100 may also be movable so that the detection part and the pushing member 310 are provided opposite to each other by moving the detection member 20. In addition, both the pushing member 310 and the distance detector 100 may also be movable, which is not limited here.

In an embodiment, the state conversion member may further include a pressing member 331 provided on the device body 300, so that when the detection member 20 needs to be moved to the detection position, the pressing member 331 abuts against the detection member 20 to drive the detection member 20 to move to the detection position relative to the housing 10. Or, an elastic ratchet mechanism such as that used in a push-type ballpoint pen may be used between the detection member 20 and the housing 10. The state conversion member may only be provided with a pushing member 310, and the detection member 20 may be repeatedly converted between the idle position and the detection position by repeatedly pressing the detection member 20. With such a configuration, the detection member 20 may be repeatedly converted between the idle position and the detection position by using a purely mechanical structure, without the need to provide other electrical connection structures, so that the overall structure of the processing device 1000 is relatively simple.

In an embodiment of the present application, the distance detector 100 is movably provided on the device body 300, and when the detection member 20 needs to be switched to the idle position, the distance detector 100 moves to a position where the detection part is opposite the pushing member 310.

In an embodiment, the distance detector 100 is movably provided, including moving the distance detector 100 so that the detection part and the pushing member 310 are provided opposite to each other and moving the detection part and the pushing member 310 to be staggered. The distance detector 100 can also be moved in the extension direction of the detection member 20 to approach and move away from the pushing member 310. In this way, there is no need to move the pushing member 310, so that the structure of the pushing member 310 is relatively simple.

As shown in FIG. 10, in some embodiments of the present application, the device body 300 includes a processing surface. The distance detector 100 is movably provided above the processing surface. The pushing member 310 is provided at the edge of the processing surface.

In an embodiment, a processing surface is formed on the device body 300, and an installation part 340 for fixing the pushing member 310 is provided at the edge of the processing surface, so that the pushing member 310 can be fixed at the edge position of the processing surface. With such configuration, when the distance detector 100 detects the distance between the workpiece to be processed placed on the processing surface, the distance between the processing head 320 and the workpiece to be processed is obtained. When the processing head 320 is processing, it is avoided that the pushing member 310 interferes with the processing head 320 or the distance detector 100. Only when the distance detector 100 is not needed, the distance detector 100 is moved to the edge of the processing surface to cooperate with the pushing member 310 to retract the detection member 20, thereby improving the stability of the processing process of the processing device 1000.

As shown in FIG. 11, in some embodiments of the present application, the pushing member 310 includes a top plate 311 and a side plate 312. The top plate 311 is used to abut against the detection member 20. The side plate 312 is located below the top plate 311 and connected to the top plate 311 to fix the pushing member 310.

In an embodiment, the pushing member 310 includes a top plate 311 and a side plate 312 that are interconnected. The top plate 311 is roughly horizontally provided to abut against the detection member 20. The side plate 312 is located below the top plate 311 and is provided at an angle to the top plate 311 and is connected to the top plate 311. The side plate 312 is used to connect and fix the pushing member 310 to the installation position.

As shown in FIG. 11, in some embodiments of the present application, the pushing member 310 further includes a stiffener 313, and the stiffener 313 is respectively connected to two ends of the top plate 311 and the side plate 312 that are away from each other, so that the pushing member 310 is configured to be a triangular structure.

In an embodiment, the stiffeners 313 is connected to the ends of the top plate 311 and the side plates 312 that are away from each other. The triangular structure is a stable structure, with such arrangement, when the detection member 20 is pressed down, it abuts against the top plate 311. With the support of the stiffeners 313 and the side plates 312, the top plate 311 provides a stable reaction force for the detection member 20 to retract the detection member 20. In addition, the top plate 311 is not easy to deform or bend, thereby improving the stability and safety of the retraction process of the detection member 20.

As shown in FIG. 10, in an embodiment of the present application, the device body 300 includes a motion frame 330, a first guide rail 350 and a second guide rail 360. The motion frame 330 is slidably connected to the first guide rail 350, the first guide rail 350 is slidably connected to the second guide rail 360, and the side plate 312 of the pushing member 310 is connected to the second guide rail 360 so that the pushing member 310 is fixed on the second guide rail 360. The pushing member 310 is located below the motion frame 330.

In an embodiment, a motion frame 330 for fixing the distance detector 100 is provided on the device body 300, and the motion frame 330 can drive the distance detector 100 to translate in the extension direction of the first guide rail 350 and the extension direction of the second guide rail 360, so that the distance detector 100 can be moved to different positions of the device body 300 for distance measurement. The motion frame 330 is provided on the first guide rail 350, the first guide rail 350 is provided on the second guide rail 360, and the first guide rail 350 can drive the motion frame 330 to slide on the second guide rail 360. The pushing member 310 is provided on the second guide rail 360, and the pushing member 310 is relatively fixed in the device body 300. By driving the distance detector 100 to move, the detection part of the detection member 20 is provided relative to the pushing member 310. In addition, in the embodiment of the present application, the motion frame 330 includes a bracket 333 and a back plate 332. The bracket 333 is slidably provided on the first guide rail 350, and the back plate 332 is movably provided on the bracket 333. The distance detector 100 is provided on the back plate 332, so that the distance detector 100 can be lifted and lowered, and the detection member 20 of the distance detector 100 can be lowered to abut against the position to be detected. The height of the pushing member 310 is lower than the height of the motion frame 330. In this way, when the detection part of the detection member 20 is located above the pushing member 310, the detection part can be abutted against the pushing member 310 by driving the distance detector 100 to descend.

As shown in FIGS. 7 and 8, in some embodiments of the present application, a top wall of the housing 10 is provided with an avoidance hole 11, and one end of the detection member 20 inserted in the housing 10 can extend from the avoidance hole 11 to form a pressing part 21.

In an embodiment, the upper end of the detection member 20 is used as the pressing part 21 of the detection member 20, and correspondingly, an avoidance hole 11 for the detection member 20 to pass through is provided on the top wall of the housing 10. In this way, the detection member 20 can be a branch structure, and there is no need to provide an additional pressing structure on the side wall of the detection member 20, which makes the structure of the detection member 20 complicated. The retraction height of the detection member 20 does not need to be limited by the height of the housing 10, and the detection member 20 can be retracted upward as much as possible, reducing the length of the detection member 20 protruding from the bottom of the housing 10, and even making the lower end of the detection member 20 completely retracted into the housing 10, which is more conducive to reducing the risk of damage to the detection member 20 when the distance detector 100 is in an idle state, thereby improving the safety of use.

As shown in FIGS. 10 and 12, in some embodiments of the present application, the processing device 1000 is provided with a processing head 320, the processing head 320 is fixedly connected to the back plate 332, the housing 10 of the distance detector 100 is detachably connected to the housing of the processing head 320, and the back plate 332 is used to drive the processing head 320 to rise and fall on the bracket 333 to drive the distance detector 100 to move synchronously.

It can be understood that the processing device 1000 of the present application can be a laser processing device such as a laser engraving machine, a laser cutting machine, a laser marking machine, or a processing device such as a printer, and correspondingly, the processing head 320 is a laser head or a printing nozzle. In an embodiment, the distance detector 100 is fixed on the processing head 320 and is detachably connected to the processing head 320, so that the distance detector 100 and the processing head 320 move synchronously. The distance detector 100 can detect the distance between the position to be processed and the processing head 320 in real time, and the relative position of the distance detector 100 and the processing head 320 remains unchanged, avoiding the problem of inaccurate measurement caused by height deviation due to the asynchronous movement distance when the distance detector 100 and the processing head 320 move separately, which is conducive to improving the measurement accuracy; and reducing the quantity of lifting structures and translation structures in the processing device 1000. Only one set of lifting structures and one set of translation mechanisms are needed to make the processing head 320 and the distance detector 100 move synchronously, simplifying the structure of the processing device 1000.

As shown in FIGS. 10 to 12, in some embodiments of the present application, the motion frame 330 further includes two brackets 333, which are respectively provided on both sides of the back plate 332 to enclose a guide groove 334, and the processing head 320 can be raised and lowered in the guide groove 334.

In an embodiment, the motion frame 330 roughly forms a guide rail structure, the motion frame 330 includes a back plate 332 as an installation base, two brackets 333 provided on both sides of the back plate 332, and a guide groove 334 extending in the height direction is formed between the two brackets 333. The processing head 320 is provided between the two brackets 333, so that the processing head 320 is raised and lowered along the guide groove 334 on the motion frame 330, so as to guide and limit the lifting process of the processing head 320, improve the stability of the lifting process of the processing head 320, and avoid the displacement of the processing head 320 and the distance detector 100 during the lifting process.

In an embodiment, when the processing head 320 is provided in the guide groove 334, a part of the processing head 320 protrudes out of the guide groove 334, so that the distance detector 100 installed on the side of the processing head 320 is located on the surface of one of the brackets 333, and the pressing piece 331 is provided on the surface of the bracket 333 so that it is located above the distance detector 100. Therefore, when the processing head 320 rises along the guide groove 334, the pressing piece 331 can abut against the upper end of the detection member 20 to make the detection member 20 descend relative to the housing 10 and move to the detection position to prepare for distance detection.

The pressing member 331 and the motion frame 330 may be an integrated structure, or the pressing member 331 may be simply fixed on the motion frame 330, which is not limited here.

In some embodiments of the present application, the state conversion element is an electromagnet assembly, a magnet with magnetic poles is provided on the detection member 20, and the electromagnet assembly is provided corresponding to the magnet. The electromagnet assembly is used to generate an adsorption force to adsorb the magnet so that the detection member 20 moves from the detection position to the idle position. Or, the electromagnet assembly is used to generate a thrust force that repels the magnet so that the detection member 20 moves from the idle position to the detection position.

In an embodiment, the state conversion member may further include an electromagnet assembly, and a magnet needs to be provided on the detection member 20 accordingly. When the position of the detection member 20 needs to be adjusted, the electromagnet assembly can be used to generate an adsorption force of the adsorbing magnet or a thrust force to repel the magnet when it is energized, so that the detection member 20 moves from the detection position to the idle position or from the idle position to the detection position. Two sets of electromagnet assemblies can be provided to respectively drive the detection member 20 from the detection position to the idle position and to drive the detection member 20 from the idle position to the detection position. Or, at least one set of electromagnet assemblies and a pushing member 310 as in the above embodiment can be provided to drive the detection member 20 from the detection position to the idle position, or at least one set of electromagnet assemblies and a pressing member 331 can be provided to drive the detection member 20 from the idle position to the detection position.

The above are only some embodiments of the present application, and do not limit the scope of the present application thereto. Under the inventive concept of the present application, equivalent structural transformations made according to the description and drawings of the present application, or direct/indirect application in other related technical fields are included in the scope of the present application.

What is claimed is:

1. A distance detector, comprising:
a housing;
a detection member; and
a trigger connected to the detection member,
wherein a part of the detection member is slidably inserted into the housing along a length direction of the detection member; and the trigger is configured to move with a sliding of the detection member to trigger a sensing member provided at a first installation position.

2. The distance detector according to claim 1, wherein a guide slot extending along the length direction of the detection member is provided on a side surface of the housing, the trigger is at least partially located outside the housing and configured to slide in the guide slot with the sliding of the detection member to trigger the sensing member.

3. The distance detector according to claim 2, wherein the sensing member comprises a transmitting end and a receiving end, and the trigger is configured to slide into or out of a space between the transmitting end and the receiving end to block the receiving end from receiving a signal emitted by the transmitting end.

4. The distance detector according to claim 1, further comprising:
an elastic reset member provided in the housing,
wherein the elastic reset member is drivingly connected to the detection member to apply a force to the detection member to extend out of the housing.

5. The distance detector according to claim 4, wherein a stopper is provided in the housing, the trigger is connected to a side surface of the stopper, and the stopper is sleeved outside the detection member and fixedly connected to the detection member.

6. The distance detector according to claim 5, wherein:
the housing comprises a top wall and a bottom wall opposite to the top wall, and the detection end of the detection member is provided through the bottom wall; and
the elastic reset member is sleeved on the outer side of the detection member and is provided between the top wall and the stop member.

7. The distance detector according to claim 5, wherein:
the housing comprises a top wall and a bottom wall opposite to the top wall, and the detection end of the detection member is provided through the bottom wall; and
the top wall is provided with an avoidance hole, and a force-bearing end of the detection member is configured to extend out of the housing through the avoidance hole.

8. The distance detector according to claim 5, wherein:
the detection member comprises a detection position and an idle position spaced apart along the length direction of the detection member;
the distance detector further comprises a locking structure provided in the housing and configured to fix the detection member at the idle position;
when the detection member is at the idle position, a force applied by the locking structure to the detection member is greater than a force applied by the elastic reset member to the detection member; or
when the detection member is at the detection position, the force applied by the locking structure to the detection member is less than the force applied by the elastic reset member to the detection member.

9. The distance detector according to claim 8, wherein:
the locking structure comprises a first magnetic member provided on the housing and a second magnetic member provided on at least one of the detection member and the trigger; and
the first magnetic member is configured to attract the second magnetic member when the detection member is at the idle position.

10. The distance detector according to claim 1, wherein:
the detection member comprises a detection end and a force-bearing end, and a cross-sectional area of the force-bearing end gradually increases in a direction from the force-bearing end to the detection end.

11. The distance detector according to claim 1, wherein:
a side surface of the housing is provided with a peripheral edge, the peripheral edge is enclosed to form an avoidance space, and the trigger is provided inside the avoidance space.

12. The distance detector according to claim 1, wherein:
the distance detector is detachably installed on a processing head, the processing head is provided with the first installation position and a second installation position opposite to the first installation position, the sensing member is provided at the first installation position, and the distance detector is provided at the second installation position; and
the distance detector further comprises a magnetic structure, and the magnetic structure is provided at the housing to allow the distance detector to be magnetically fixed at the second installation position.

13. The distance detector according to claim 12, wherein:
a side surface of the housing is provided with a positioning part to be plugged and matched with a positioning hole of the second installation position; or, the side surface of the housing is provided with the positioning hole to be plugged and matched with the positioning part of the second installation position.

14. A processing head, comprising:
a housing; and
a sensing member, wherein:
the housing comprises a first installation position inside, the sensing member is provided at the first installation position, the housing comprises a second installation position outside opposite to the first installation position, and the second installation position is provided with a distance detector; and
the second installation position comprises a slide slot, and a part of the trigger of the distance detector is configured to extend through the slide slot to trigger the sensing member.

15. The processing head according to claim 14, wherein:
at least two sensing members are provided along an extension direction of the slide slot; and
a first sensing member is configured to detect whether a detection member is located at a detection position, and a second sensing member is configured to detect whether the detection member is located at an idle position.

16. A processing device, comprising:
a processing head; and
the distance detector according to claim 1,
wherein the sensing member is provided inside the processing head, the distance detector is provided outside the processing head and opposite to the sensing member, and the distance detector is configured to trigger the sensing member.

17. The processing device according to claim 16, wherein a side wall of the processing head is provided with a slide slot extending in a height direction of the processing head, and a part of the trigger of the distance detector is configured to extend through the slide slot and enter the processing head to trigger the sensing member during a lifting process of the sensing member.

18. The processing device according to claim 16, wherein the distance detector is detachably connected to the processing head.

19. The processing device according to claim 18, wherein the side wall of the processing head comprises an attraction structure, and the distance detector comprises a magnetic structure connected to the attraction structure to fix the distance detector on the processing head.

20. The processing device according to claim 16, further comprising:
a device body,
wherein the device body comprises a pushing member, the processing head is movably and liftably provided at the device body, the detection member comprises a detection position and an idle position provided along a height direction relative to the housing, and when the distance detector moves to above the pushing member, the pushing member is configured to abut against the descending detection member to retract the detection member upward to the idle position.
